(19) United States
(12) Patent Application Publication
(10) Pub. No.: US 2017/0046074 A1
(43) Pub. Date: Feb. 16, 2017

(54) Adaptive Data Compression for Data Storage in a Memory Device

(71) Applicant: Intel Corporation, Santa Clara, CA (US)

(72) Inventors: REN WANG, PORTLAND, OR (US); KEN SCHUMM, BANKS, OR (US); ZESHAN A. CHISHTI, HILLSBORO, OR (US); CHRISTOPHER B. WILKERSON, PORTLAND, OR (US)

(21) Appl. No.: 14/823,548

(22) Filed: Aug. 11, 2015

(51) Int. Cl. G06F 3/06

(52) U.S. Cl. CPC G06F 3/0608; G06F 3/064; G06F 3/0643; G06F 3/0653; G06F 3/0659; G06F 3/0673

(57) ABSTRACT

Examples may include techniques for adaptive compression for data stored in a memory device. The techniques include monitoring a data access pattern to a file or a block for data stored in the memory device and determining a data compression action based on, at least in part, the monitored data access patterns for the file or the block and on an assessed relationship of the file or the block with other files or other blocks. The data compression action including compressing data accessed via the file or the block, decompressing compressed data accessed via the file or the block or no compression action for data accessed via the file or the block.

### TECHNICAL FIELD

Examples described herein are generally related to data compression to a memory device included in system memory or a storage device.

### BACKGROUND

Types of memory devices that may be included in system memory or a storage device for a computing device may often be capacity-constrained. Although technological advances have resulted in progressively larger capacities for memory devices, a faster growth for capacity demands of various types of applications has occurred. Compression techniques to compress data stored in memory devices may be potentially used as a means to increase effective capacity.

### BRIEF DESCRIPTION OF THE DRAWINGS

FIG. 1 illustrates an example first system.

FIG. 2 illustrates an example second system.

FIG. 3 illustrates an example third system.

FIG. 4 illustrates an example architecture.

FIG. 5 illustrates an example first logic flow.

FIG. 6 illustrates an example block diagram for an apparatus.

FIG. 7 illustrates an example second logic flow.

FIG. 8 illustrates an example of a storage medium.

FIG. 9 illustrates an example computing platform.

### DETAILED DESCRIPTION

As contemplated in the present disclosure, compression techniques may be potentially used as a way to increase effective capacity of a memory device included in system memory or a storage device. Compression techniques may include various system memory compression techniques that may include but are limited to memory expansion technology (MXT), linearly compressed pages (LCP), frequency pattern compression or MemZip compression. Compression techniques may also include various storage device compression techniques to include, but not limited to, a compression technique known as progressive redundancy elimination of similar and identical data in objects (PRESIDIO).

MXT may be implemented as a hardware technique for compressing the contents of main memory. By compressing the entire memory using the same compression algorithm, MXT may allow for the memory capacity to appear larger than actual physically available memory. LCP may be implemented as a technique to compress all cache lines within a given page of memory to a same size. This technique may allow a simpler calculation of physical addresses, resulting in lower decompression latency. Frequency Pattern compression may be implement as a technique to compress individual cache lines by encoding common data patterns in a compressed format accompanied with an appropriate prefix. MemZip may be implemented as a compression architecture designed explicitly for energy-efficient operation. In MemZip, a compressed cache line may be stored in only a subset of system memory devices (e.g., DRAM chips) within a rank of system memory devices (e.g., a DRAM rank). Therefore, when the compressed cache line is accessed from main or system memory, only a subset of system memory devices needs to be activated and this may result in energy savings. PRESIDIO may be implemented as an archival storage system. When storing objects or data to a storage device, PRESIDIO may result in techniques for efficient data storage by selecting from a variety of different compression methods to detect similarity and reduce data redundancy.

The above-mentioned compression techniques as well as other current compression techniques may attempt to minimize latencies for both compressing and then decompressing data stored in memory devices but they fail to consider data access pattern information that may be associated with applications using this data. So without considering data access pattern information, even if latencies are reduced, decompression of compressed data may still incur latency penalties that may negatively impact an application's performance and possibly degrade a user experience. It is with respect to these and other challenges that the examples described herein are needed.

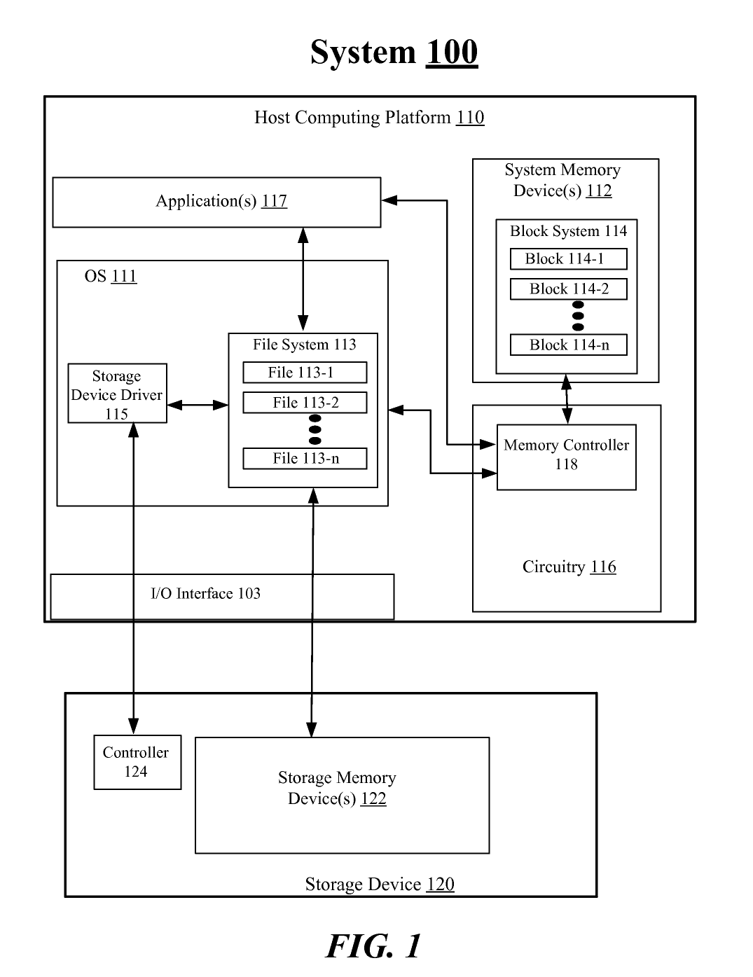

FIG. 1 illustrates an example system 100. In some examples, as shown in FIG. 1, system 100 includes a host computing platform 110 coupled to a storage device 120 through input/output (I/O) interface 103. Also, as shown in FIG. 1, host computing platform 110 may include an operating system (OS) 111, one or more system memory device(s) 112, circuitry 116 and one or more application(s) 117. For these examples, circuitry 116 may be capable of executing various functional elements of host computing platform 110 such as OS 111 and application(s) 117 that may be maintained, at least in part, within system memory device(s) 112. Circuitry 116 may include host processing circuitry to include one or more central processing units (CPUs) and associated chipsets and/or controllers.

According to some examples, as shown in FIG. 1, OS 111 may include a file system 113 and a storage device driver 115 and storage device 120 may include a controller 124 and one or more storage memory device(s) 122. OS 111 may be arranged to implement storage device driver 115 to coordinate at least temporary storage of data for a file from among files 113-1 to 113-n, where “n” is any whole positive integer >1, to storage memory device(s) 122. The data, for example, may have originated from or may be associated with executing at least portions of application(s) 117 and/or OS 111. As described in more detail below, storage device driver 115 may include logic and/or features to monitor data access patterns for data stored at storage memory device(s) 122, assess relationships of files according to monitored data access patterns and determine a data compression action for storing data accessed via a given file from among files 113-1 to 113-n at storage memory device(s) 122 based on the monitored data access patterns and/or assessed relationships.

In some examples, storage memory device(s) 122 may include one or more chips or dies that may individually include one or more types of non-volatile memory to include, but not limited to, NAND flash memory, NOR flash memory, three dimensional (3-D) cross-point memory, ferroelectric memory, silicon-oxide-nitride-oxide-silicon (SONOS) memory, polymer memory such as ferroelectric polymer memory, ferroelectric transistor random access memory (FeTRAM) or FeRAM), ovonic memory, nanowire or electrically erasable programmable read-only memory (EEPROM). For these examples, storage device 120 may be arranged or configured as a solid-state drive (SSD). Examples are not limited to storage devices arranged or configured as SSDs other storage devices such as a hard disk drive (HDD) are contemplated.

According to some examples, communications between storage device driver 115 and controller 124 for data stored in memory devices(s) 122 and accessed via files 113-1 to 113-n may be routed through I/O interface 103. I/O interface 103 may be arranged as a Serial Advanced Technology Attachment (SATA) interface to couple elements of host computing platform 110 to storage device 120. In another example, I/O interface 103 may be arranged as a Serial Attached Small Computer System Interface (SCSI) (or simply SAS) interface to couple elements of host computing platform 110 to storage device 120. In another example, I/O interface 103 may be arranged as a Peripheral Component Interconnect Express (PCIe) interface to couple elements of host computing platform 110 to storage device 120. In another example, I/O interface 103 may be arranged as a Non-Volatile Memory (NVM) Express interface to couple elements of host computing platform 110 to storage device 120.

In some examples, as shown in FIG. 1, system memory device(s) 112 may include a block system 114 having blocks 114-1 to 114-n. Each block of block system 114 may include a plurality of memory pages (not shown). Also, as shown in FIG. 1, circuitry 116 may include a memory controller 118. Memory controller 118 may be arranged to control access to data at least temporarily stored at system memory device(s) 112 for blocks 114-1 to 114-n. As described in more detail below, memory controller 118 may include logic and/or features to monitor data access patterns for data at least temporarily stored at system memory device(s) 112, assess relationships of files according to monitored data access patterns and determine a data compression action for storing data accessed via a given block from among blocks 114-1 to 114-n at system memory device(s) 112 based on the monitored data access patterns and/or assessed relationships.

System Memory device(s) 112 may include one or more chips or dies having volatile types of memory such as dynamic random access memory (DRAM) or non-volatile types of memory such as 3-D cross-point memory, NOR flash memory, ferroelectric memory, silicon-oxide-nitride-oxide-silicon (SONOS) memory, polymer memory such as ferroelectric polymer memory, ferroelectric transistor random access memory (FeTRAM) or FeRAM), ovonic memory, nanowire or electrically erasable programmable read-only memory (EEPROM).

According to some examples, host computing platform 110 may include, but is not limited to, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof.

In some examples, as described more below, adaptive data compression techniques may be implemented that may include various compression actions that may adaptively compress “cold” data and leave “hot” data uncompressed (or pre-decompress “hot” data) so that an effective capacity of a memory device may be boosted while a majority of read/write requests to data stored in the memory device may be satisfied by storing to uncompressed regions of the memory device. In some examples, “hot” data may include data accessed via a given file or block that has been recently accessed or is expected to be accessed soon compared to data accessed via other given files or blocks. Meanwhile, “cold” data may include data accessed via a given file or block that has not been recently accessed or is not expected to be accessed within a given amount of time compared to data accessed via other given files or blocks As a result of these adaptive data compression techniques, capacity benefits of compression may be achieved while minimizing or reducing delays associated with decompression latencies. As described more below, techniques may be implemented that may include logic and/or features (e.g., for a storage device driver or a memory controller) determining which files/blocks may be less likely to be accessed soon (candidates to be compressed), and which files/blocks may be more likely to be accessed soon (and should be left uncompressed). In some examples, these determinations may be based on monitored access patterns and/or file access relationships between the files/blocks (e.g., comparative order of access).

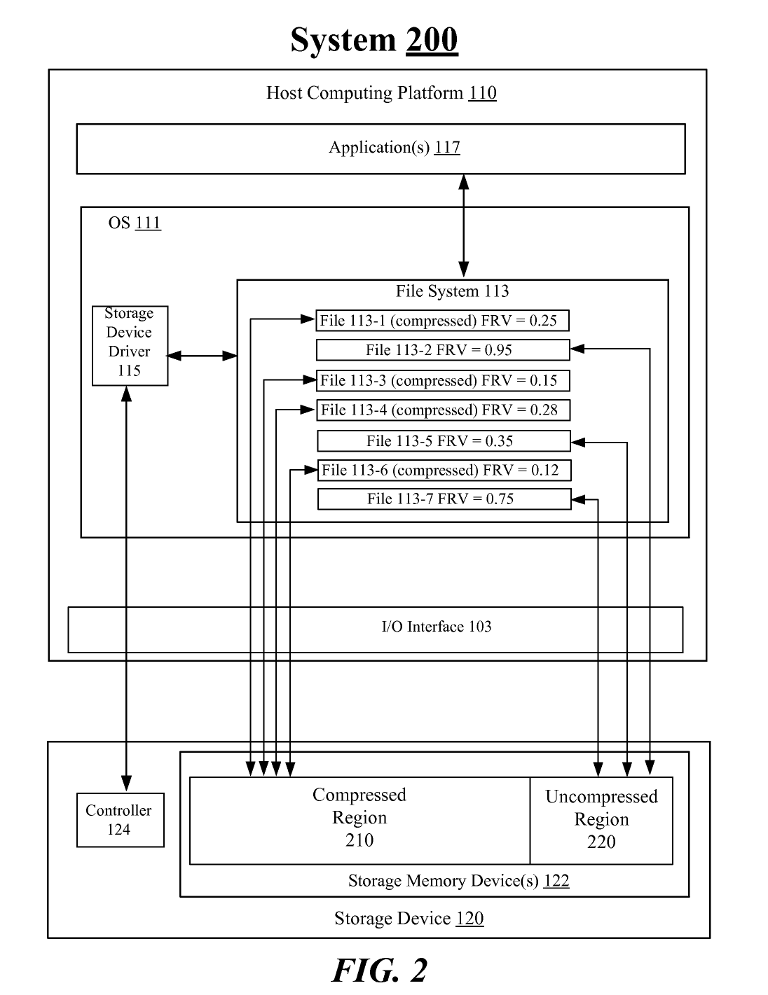

FIG. 2 illustrates an example second system. As shown in FIG. 2, the example second system includes system 200. In some examples, system 200 includes elements from system 100 such as host computing platform 110 coupled with storage device 120 through I/O interface 103. Other elements from system 100 such as application(s) 117, OS 111, storage device driver 115, file system 113, controller 124 and storage memory device 122 may also be included in system 200 as shown in FIG. 2.

According to some examples, as shown in FIG. 2, storage memory device(s) 122 includes a compressed region 210 and an uncompressed region 220. Compressed region 210 may include compressed data stored at storage memory device(s) 122 and accessed via at least a portion of files maintained in file system 113. For example, data accessed via files 113-1, 113-3, 113-4 and 113-6 may have been compressed using storage device compression technique or scheme such as PRESIDIO and stored in compressed region 210. Uncompressed region 220 may include uncompressed data stored at storage memory device(s) 122 and accessed via at least a portion of files maintained in file system 113. For example, data accessed via files 113-2, 113-5 and 113-7 may be stored in an uncompressed format to uncompressed region 220.

In some examples, logic and/or features of storage device driver 115 may be capable of monitoring data access patterns to files included in file system 113 to access data stored in memory device(s) 122. For example, the logic and/or features may monitor access patterns by application(s) 117. Based on these monitored data access patterns, the logic and/or features may assign a value that indicates whether recently accessed files are considered “hot” and data accessed via these file should not be compressed for performance reasons and also indicates a frequency of access. This value is hereafter referred to as a frequency-recency value (FRV) and FRV may indicate how likely data for a given file may be accessed again. FRV may be based on any algorithm or equation that takes into account both how recent and how frequent the data has been accessed via a given file. For example, RFV may be determined using a weighted exponentially moving average (WEMA) that is based on the data access pattern associated with the given file. Such a WEMA may be represented by example equation (1):

FRVₖ=*FRVₖ₋₁+(1−)*sample (1)

For example equation (1), FRVₖ may represent a new FRV, FRVₖ₋₁may represent an immediately preceding FRV, may represent a weighting decrease that may be applied to discount older observations of data access via a file, and sample may represent data access via a file recency. A higher relative value for FRV for a given individual file compared to other individual files may indicate that data access via the given individual file is more likely to occur soon and the given individual file may be considered “hot” or at least “hotter” than the other individual files having lower FRVs.

According to some examples for example equation (1), sample may be represented by a value of 1 for data access via an individual file that has been currently accessed or −1 for data access via an individual file that has not been currently accessed. For these examples, the weighting decrease for may be a value chosen between 0 and 1, where a higher value for may discount older observations of data access via the individual file faster. By discounting older observations faster, data access via the individual file that has been currently accessed (represented as recency) may be smoothed over time, while the WEMA gives more weight to recent samples. Thus both frequency and recency information may be captured by example equation (1). Examples are not limited to example equation (1) for determining recency and frequency of monitored data access patterns, other equations are algorithms may be used to determine recency and frequency of data access via individual files.

In some examples, individual RFVs for files 113-1 to 113-7 may have been assigned by logic and/or features of storage device driver 115. For these examples, the individual RFVs may have been determined using example equation (1) based on monitored data access patterns to these files for data stored in storage memory device(s) 122. Files 113-1, 113-3, 113-4 and 113-6 having RFVs comparatively lower than RFVs for files 113-2, 113-5 and 113-7 may provide access to compressed data stored in compressed region 210. Meanwhile, files 113-2, 113-5 and 113-7 may be considered relatively “hot” and therefore may provide access to uncompressed data stored in uncompressed region 220.

According to some examples, in addition to using an RFV to determine whether to store data in a compressed or uncompressed region, logic and/or features of storage device driver 115 may be capable of assessing a relationship of a data access pattern for a given file in file system 113 with respective one or more other data access patterns to one or more other files in file system 113. For these examples, the logic and/or features may monitor an application data access pattern of application(s) 117 for data accessed via the given file and for data accessed via the one or more other files and determine whether access via the given file for the monitored application data access pattern indicates a given order of access that includes access to data via a first file from among the files in file system 113 followed by access to data via the given file. The logic and/or features may place a high relationship value to the first file if the application data access pattern indicates the given order of access. As described more below, the high relationship value may be based on a relationship graph or map generated based on a monitored application data access pattern.

In some examples, logic and/or features of storage device driver 115 may be capable of determining whether data accessed via the first file from among the files of file system 113 has been accessed within a time threshold. For these examples, the time threshold may be established such that if the given file from among the files of file system 113 was used to access compressed data, then a compression action to decompress data accessed via the given file may be completed before an expected access is to occur based on its relationship with the first file. Responsive to the logic and/or features determining that data accessed via the first file has been accessed within the time threshold (e.g., 100 or 200 microseconds), the logic and/or features may determine that a compression action for data accessed via the given file is to decompress data if the data is in a compressed state (e.g., stored in compressed region 210) or to do no compression if data accessed via the given file is not in a compressed state (e.g., stored to uncompressed region 220).

According to some examples, logic and/or features of storage device driver 115 may be capable of graphing relationships between files included in file system 113 based on monitored application data access patterns. For example, application(s) 117 may have application data access patterns to files included in file system 113 that indicate whenever file 113-5 is accessed then file 113-4 is accessed. Thus a graph may be generated that indicates that following data access via file 113-5 that access to file 113-4 is likely. This relationship, for example, may override a relatively low RFV and cause the logic and/or features to initiate a compression action that may result in data accessed via file 113-4 being decompressed. As mentioned previously, a time threshold for a related access may also be established. In other words, even if application data access patterns indicated related access, if the related accesses are spaced apart in time, then decompression of compressed data may not be needed and for these instances the relationship may not override the relatively low RFV value for file 113-4.

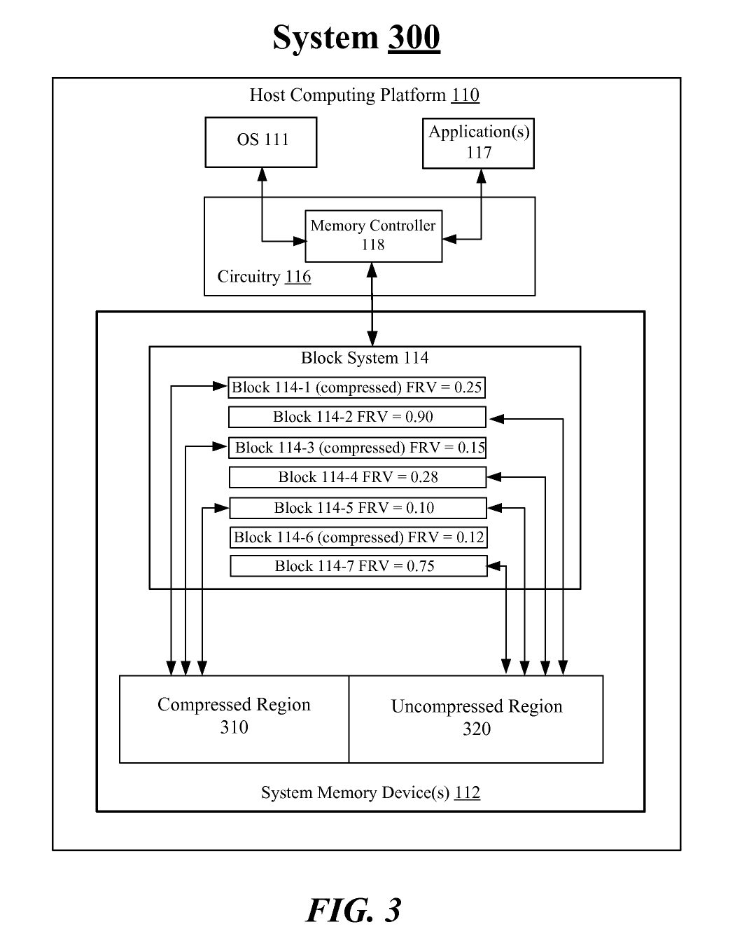

FIG. 3 illustrates an example third system. As shown in FIG. 3, the example third system includes system 300. In some examples, system 300 includes elements from system 100 such as host computing platform 110, OS 111, application(s) 117, circuitry 116 and system memory device(s) 112. According to some examples, as shown in FIG. 3, system memory device(s) 112 includes a compressed region 310 and an uncompressed region 320. Compressed region 310 may include compressed data stored at system memory device(s) 112 and accessed via at least a portion of blocks maintained in block system 114. For example, data accessed via files 114-1, 114-3 and 114-6 may have been compressed using a system memory compression technique or scheme such as MXT, LCP, frequency pattern or MemZip and stored in compressed region 310. Uncompressed region 320 may include uncompressed data stored at system memory device(s) 112 and accessed via at least a portion of files maintained in block system 114. For example, data accessed via blocks 114-2, 114-4, 114-5 and 114-7 may be stored in an uncompressed format to uncompressed region 320.

In some examples, logic and/or features of memory controller 118 may be capable of monitoring data access patterns to blocks included in block system 114 to access data stored in system memory device(s) 112. For these examples, the logic and/or features may be capable of monitoring the data access pattern for data accessed via these blocks that each include a plurality of memory pages (not shown). For example, the logic and/or features may monitor access patterns by application(s) 117 to memory pages included in each block. Based on these monitored data access patterns, the logic and/or features may assign an FRV that indicates whether recently accessed blocks are considered “hot” and data accessed via these blocks should not be compressed for performance reasons and also indicates a frequency of access. The assigned FRV may be on a WEMA represented by example equation (1) as described above.

According to some examples, for using example equation (1), FRVk may represent a new FRY, FRVₖ₋₁ may represent an immediately preceding FRV, may represent a weighting decrease that may be applied to discount older observations of data access via a block, and sample may represent data access via a block recency. A higher relative value for FRV for a given individual block compared to other individual blocks may indicate that data access via the given individual block is more likely to occur soon and the given individual block may be considered “hot” or at least “hotter” than the other individual blocks having lower FRVs.

In some examples for use of example equation (1), sample may be represented by a value of 1 for data access via an individual block that has been currently accessed or −1 for data access via an individual block that has not been currently accessed. For these examples, the weighting decrease for may be a value chosen between 0 and 1, where a higher value for may discount older observations of data access via the individual block faster. By discounting older observations faster, data access via the individual block that has been currently accessed (represented as recency) may be smoothed over time, while the WEMA gives more weight to recent samples. Thus both frequency and recency information may be captured when using example equation (1). Examples are not limited to example equation (1) for determining recency and frequency of monitored data access patterns, other equations are algorithms may be used to determine recency and frequency of data access via individual blocks.

According to some examples, individual RFVs for blocks 114-1 to 114-7 may have been assigned by logic and/or features of memory controller 118. For these examples, the individual RFVs may have been determined using example equation (1) based on monitored data access patterns to these blocks for data stored in system memory device(s) 112. Blocks 114-1, 114-3 and 114-6 having RFVs comparatively lower than RFVs for blocks 114-2, 114-4, 114-5 and 114-7 may provide access to compressed data stored in compressed region 310. Meanwhile, blocks 114-2, 114-4 and 114-5 may be considered relatively “hot” and therefore may provide access to uncompressed data stored in uncompressed region 230.

According to some examples, in addition to using an RFV to determine whether to store data in a compressed or uncompressed region, logic and/or features of memory controller 118 may be capable of assessing a relationship of a data access pattern for a given block in block system 114 with respective one or more other data access patterns to one or more other blocks in block system 114. For these examples, the logic and/or features may monitor an application data access pattern of application(s) 117 for data accessed via the given block and for data accessed via the one or more other blocks and determine whether access via the given block for the monitored application data access pattern indicates a given order of access that includes access to data via a first block from among the blocks in block system 114 followed by access to data via the given block. The logic and/or features may place a high relationship value to the first block if the application data access pattern indicates the given order of access.

In some examples, logic and/or features of memory controller 118 may be capable of determining whether data accessed via the first block from among the blocks of block system 114 has been accessed within a time threshold. For these examples, the time threshold may established such that if the given block from among the blocks of block system 114 was used to access compressed data, then a compression action to decompress data accessed via the given block may be completed before an expected access is to occur based on its relationship with the first block. Responsive to the logic and/or features determining that data accessed via the first block has been accessed within the time threshold, the logic and/or features may determine that a compression action for data accessed via the given block is to decompress data if the data is in a compressed state (e.g., stored in compressed region 310) or to do no compression if data accessed via the given block is not in a compressed state (e.g., stored to uncompressed region 320).

According to some examples, logic and/or features of memory controller 118 may be capable of graphing or mapping relationships between blocks included in block system 114 based on monitored application data access patterns. For example, application(s) 117 may have application data access patterns to blocks included in block system 114 that indicate whenever block 114-4 is accessed then block 114-1 is accessed. Thus a graph/map may be generated that indicates that following data access via block 114-4 that access to block 114-1 is likely. This graphed or mapped relationship, for example, may override a relatively low RFV and cause the logic and/or features to initiate a compression action that may result in data accessed via block 114-1 being decompressed. As mentioned previously, a time threshold for a related access may also be established. In other words, even if application data access patterns indicated related access, if the related accesses are spaced apart in time, then decompression of compressed data may not be needed and for these instances the relationship may not override the relatively low RFV value for block 114-1.

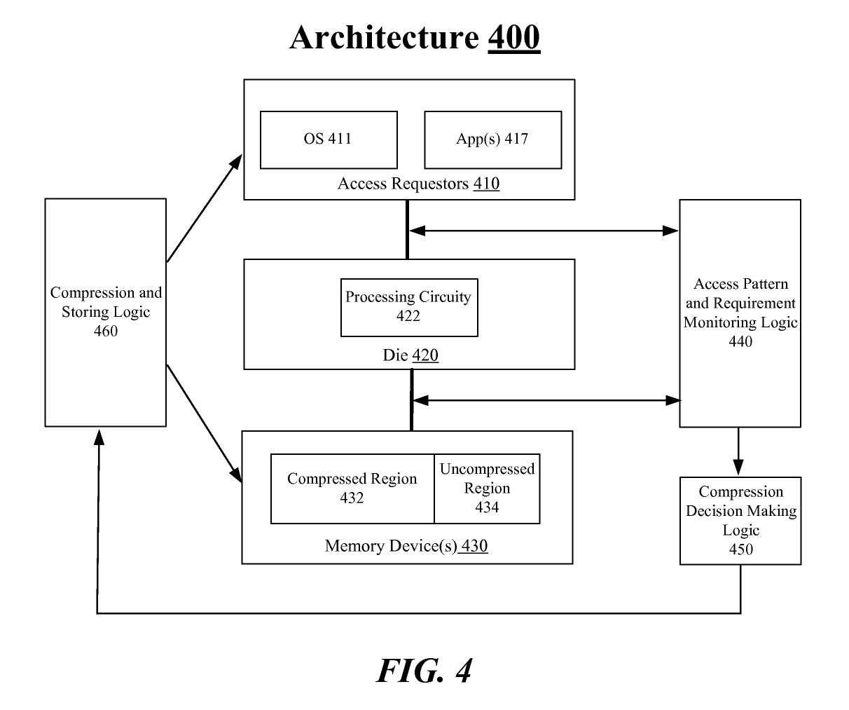

FIG. 4 illustrates an example architecture 400. In some examples, architecture 400 depicts an example of an adaptive and dynamic compression architecture for a computing platform (e.g., host computing platform 110) that includes data access requesters 410 having an OS 411 and applications(s) 417, a die 420 having processing circuitry 422 and memory device(s) 430 having compressed region 432 and uncompressed region 434.

According to some examples, architecture 400 may include an access pattern and requirement monitoring logic 440. For these examples, access pattern and requirement monitoring logic 440 may monitor a data access pattern from access requestors 410, either from a file level or a block level. At a file level, access pattern and requirement monitoring logic 440 may include logic and/or features similar to those described above for storage device driver 115 in FIGS. 1-2. At a block level, access pattern and requirement monitoring logic 440 may include logic and/or features similar to those described above for memory controller 118 in FIGS. 1 and 3.

In some examples, access pattern and requirement monitoring logic 440 may also monitor requirements related to access of data stored in memory device(s) 430. For these examples, applications 417 or OS 411 may indicate requirements to indicate that data access via a file or block is to not be compressed. In other words, this data may have a high priority or a low tolerance for access latency that may not be met if the data were stored to compressed region 432 of memory device(s) 430.

According to some examples, as shown in FIG. 4, architecture 400 may also include compression decision making logic 450. Compression decision making logic 450 may take inputs obtained from access pattern and requirement monitoring logic 440 and apply them to an adaptive algorithm or equation such as example equation (1) to decide what compression action may be taken for files or blocks used to access data stored in memory device(s) 430. Also, relationships and monitored requirements may be used to determine what compression action may be taken for these files or blocks. At a file level, compression decision making logic 450 may include logic and/or features similar to those described above for storage device driver 115 in FIGS. 1-2. At a block level, compression decision making logic 450 may include logic and/or features similar to those described above for memory controller 118 in FIGS. 1 and 3.

In some examples, as shown in FIG. 4, architecture 400 may also include compression and storing logic 460. Compression and storing logic 460 may be capable of carrying out compression actions as determined by compression decision making logic 450. The compression actions may include compressing data accessed via files or blocks and storing compressed data to compressed region 432. The compression actions may include uncompressing data accessed via files or blocks that was stored in compressed region 432 and then storing this uncompressed data to uncompressed region 434. The compression actions may include taking no compression actions for data accessed via files or blocks and stored to either compressed region 432 or uncompressed region 434. Once the compression action(s) has been completed by compression and storing logic 460, the file(s) or block(s) may have associated tags updated to indicate to OS 411 or application(s) 417 where to find data accessed via the file(s) or block(s) and stored in either compressed region 432 or uncompressed region 434.

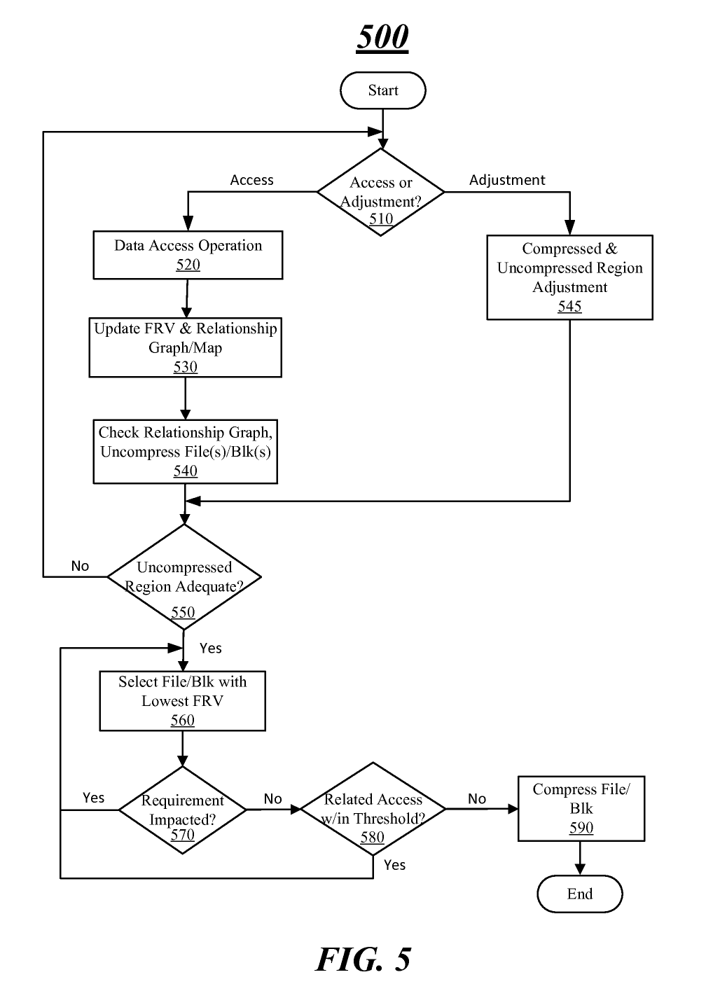

FIG. 5 illustrates an example flow 500. According to some examples, flow 500 may be implemented by logic and/or features capable of determining a compression action based on an adaptive and dynamic compression scheme for data accessed via files or blocks and stored to one or more memory devices. For these examples, flow 500 may be implemented by components or elements of architecture 400 shown in FIG. 4 such as access pattern and requirement monitoring logic 440, compression decision making logic 450 or compression and storing logic 460. However, flow 500 is not limited to being implemented by these component or elements of architecture 400.

Moving from the start to decision block 510 (Access or Adjustment?), compression decision making logic 450 may determine whether a compression action decision is needed based on access to data stored in a memory device or an adjustment to proportions of capacity for the memory device that may include compressed and uncompressed data. If access is the cause for the compression action decision, the flow moves to block 520. Otherwise the flow moves to block 545.

Moving from decision block 510 to block 520 (Data Access Operation), applications 417 or OS 411 may access data stored in memory device(s) 430 via files or blocks.

Proceeding from block 520 to block 530 (Update FRV & Relationship Graph/Map), access pattern and requirement logic 440 may monitor data access patterns to a given file or block for data stored in memory device(s) 430 and then relay this monitored information for compression decision making logic 450 to update one or more FRVs for files or blocks and/or update a relationship graph/map for these files or blocks that indicates relative order of access to data via these files or blocks. In some examples, the FRVs may be updated based on example equation (1) and the relationship graph/map may be updated based on a comparison of application data access patterns between individual files or individual blocks.

Proceeding from block 530 to block 540 (Check Relationship Graph, Uncompress File(s)/Blks), compression decision making logic 450 may check the relationship graph and determine whether the relationship graph indicates a compression action that includes uncompressing at least some of the files or blocks. As mentioned previously, a relationship graph may indicate whether monitored data access patterns indicate a particular order of access that indicates that a given file or block will be accessed following access to another file or block.

Moving from decision block 510 to block 545 (Compressed & Uncompressed Region Adjustment), compression and storing logic 460 may need to re-adjust the proportion of compressed and uncompressed regions of memory device(s) 430. In some examples, overall average access latencies for data stored in memory device(s) 430 may exceed acceptable levels (e.g., as set by quality of service requirements and/or application requirements). For these examples, the effective memory capacity of memory device(s) 430 may be need to be shortened to reduce average access latencies. In other words, the compressed region 432 may be re-adjusted to reduce its portion of the memory capacity and uncompressed region 434 may be re-adjusted to increase its portion of the memory capacity. As a result of decreasing compressed region 432's portion of the memory capacity, the effective memory capacity of memory device(s) 430 is reduced.

Proceeding from blocks 540 or 545 to decision block 550 (Uncompressed Region Adequate?), compression and storing logic 460 may determine whether uncompressing of files or blocks at block 540 or re-adjusting at block 545 resulted in uncompressed region 434 being of a capacity that is adequate to cause average access latencies to reach acceptable levels. If not adequate, the flow moves to decision block 510. Otherwise, the flow moves to block 560.

Moving from decision block 550 to block 560 (Select File/Blk with lowest FRV), compression decision making logic 450 may select a file or block having the lowest comparative FRV. In some examples, uncompressed region 434 may have a capacity that is more than adequate to meet average access latencies and thus additional data accessed via at least one file or block may be compressed and stored to compressed region 432. Data accessed via a file or block having a lowest comparative FRVs may be selected by compression decision making logic 450 as a candidate for compression.

Proceeding from block 560 to decision block 570 (Requirement Impacted?), compression decision making logic 450 may determine whether a requirement monitored by access pattern and requirement monitoring logic 440 would be impacted if the selected candidate for compression was compressed. If the requirement is impacted, the flow moves to block 560 to select a different candidate. Otherwise, the flow moves to block 580.

Moving from decision block 570 to decision block 580 (Related Access w/in Threshold?), compression decision making logic 440 may determine whether a related access to another file or block is within a time threshold. In some examples, the relationship graph/map updated at block 530 may indicate the candidate file or block has a relationship with the other file or block such that data access via the other file or block will be followed by the data access via the candidate file or block. A time threshold may be set that may still allow data accessed via the candidate file or block to be compressed if the relationship indicates that the data access will be at a time period that is outside of or greater than this time threshold. The time threshold may also consider an amount of time needed to uncompress this data accessed via the candidate file or block if the data is compressed. If within the time threshold, the flow moves to block 560 and a different candidate is selected. Otherwise, the flow moves to block 590.

Moving from decision block 580 to block 590 (Compress File/Blk), compression decision making logic 450 may decide that data accessed via the candidate file or block is to be compressed and notifies compression and storing logic 460 to compress the data accessed via the candidate file or block. The flow then comes to an end.

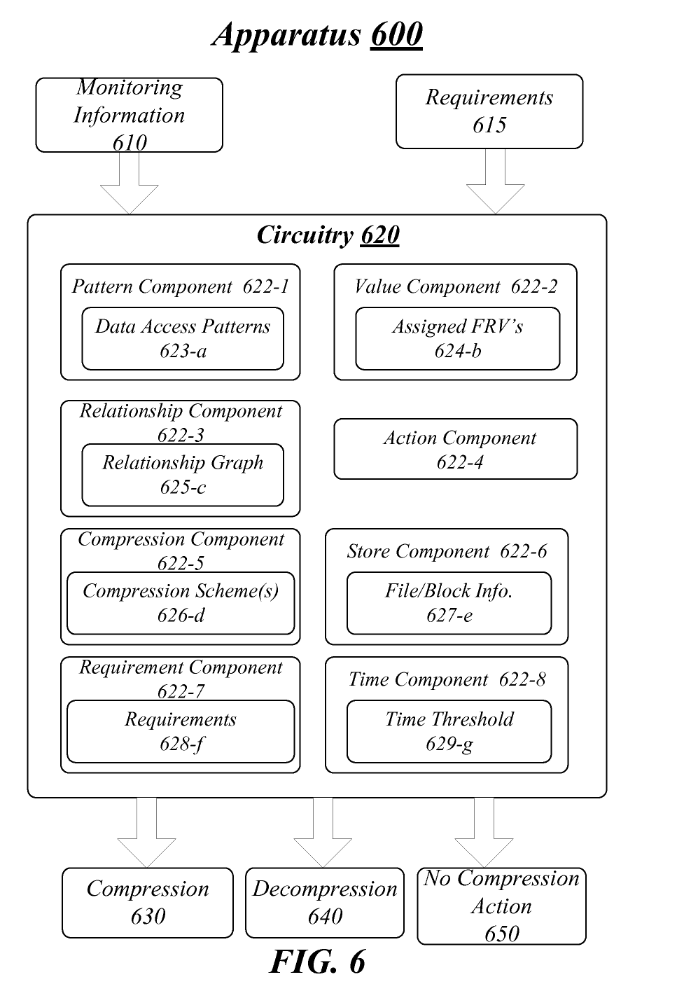

FIG. 6 illustrates an example block diagram for an apparatus 600. Although apparatus 600 shown in FIG. 6 has a limited number of elements in a certain topology, it may be appreciated that the apparatus 600 may include more or less elements in alternate topologies as desired for a given implementation.

The apparatus 600 may be supported by circuitry 620 that may be maintained at a host computing platform similar to circuitry 116 at host computing platform 110 shown in FIG. 1. Circuitry 620 may be capable of enabling an OS such as OS 111 to implement a storage device driver such as storage device driver 115 to facilitate access to storage memory devices included in a storage device such as storage device 120. Circuitry 620 may also be capable of enabling a memory controller such as memory controller 118 that controls access to system memory devices such as system memory device(s) 112. Circuitry 620 may be arranged to execute one or more software or firmware implemented components or modules 622-a (e.g., implemented as part of a storage device driver by an OS for the host computing platform or as part of a memory controller). It is worthy to note that “a” and “b” and “c” and similar designators as used herein are intended to be variables representing any positive integer. Thus, for example, if an implementation sets a value for a=8, then a complete set of software or firmware for components or modules 622-a may include components 622-1, 622-2, 622-3, 622-4, 622-5, 622-6, 622-7 or 622-8. The examples presented are not limited in this context and the different variables used throughout may represent the same or different integer values.

According to some examples, circuitry 620 may include a processor or processor circuitry. The processor or processor circuitry can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. According to some examples circuitry 620 may also be an application specific integrated circuit (ASIC) and at least some components 622-a may be implemented as hardware elements of the ASIC.

According to some examples, apparatus 600 may include a pattern component 622-1. Pattern component 622-1 may be executed by circuitry 620 to monitor a data access pattern to a file or block for data stored in a memory device. For these examples, pattern component 622-1 may include observed or monitoring data access patterns obtained from monitoring information 610 in data access patterns 623-a (e.g., as part of a data structure such a pattern lookup table (LUT)).

In some examples, apparatus 600 may also include a value component 622-2. Value component 622-2 may be executed by circuitry 620 to assign an FRV to the file or block based on the data access pattern monitored by pattern component 622-1. Value component 622-2 may include this assigned FRV in assigned FRV's 624-b (e.g., maintained in an FRV LUT).

According to some examples, apparatus 600 may also include a relationship component 622-3. Relationship component 622-3 may be executed by circuitry 620 to assess a relationship of the data access pattern for the file or the block with respective one or more other data access patterns to one or more other files or other blocks for data stored in the memory device. Relationship component 622-2 may generate a relationship graph and include this in relationship graph 625-c (e.g., maintained in a relationship LUT).

According to some examples, apparatus 600 may include an action component 622-4. Action component 622-4 may be executed by circuitry 620 to determine a data compression action for storing data in the memory device accessed via the file or the block based on, at least in part, the assigned FRV and the assessed relationship. For these examples, the data compression action may include compressing, not compressing or decompressing data accessed via the file or block. Compressing may be indicated via compression 630, decompression via compression 640 and not compressing via no compression action 650.

In some examples, apparatus 600 may also include a compression component 622-5. Compression component 622-5 may be executed by circuitry 620 to compress the data responsive to the action component 622-4 determining the data compression action is to include compressing the data using a data compression scheme. The data compression scheme may be included in compression scheme(s) 626-d (e.g., maintained in a scheme LUT). Compression scheme(s) 626-d may include system memory compression schemes such as MXT, LCP, frequency pattern or MemZip or progressive redundancy elimination of similar and identical data in objects (PRESIDIO).

According to some examples, apparatus 600 may also include a store component 622-6. Store component 622-6 may be executed by circuitry 620 to store either compressed or uncompressed data accessed via the file or the block to the memory device. For these examples, file or block information indicating where this data is stored in the memory device may be included in file/block info. 627-e (e.g., maintained in an info. LUT).

According to some examples, apparatus 600 may include a requirement component 622-7. Requirement component 622-7 may be executed by circuitry 620 to receive one or more requirements related to access of data stored in the memory device via the file or the block. For these examples, the requirements may be included in requirements 615 and may be maintained in requirements 628-f (e.g., maintained in a requirements LUT). In some examples, action component 622-4 may have access to requirements 628-f and may determine the data compression actions based on requirements included in requirements 628-f.

In some examples, apparatus 600 may also include a time component 622-8. Time component 622-8 may be executed by circuitry 620 to determine whether data accessed via a related first file or first block has been accessed within a time threshold. The amount of time may be included in time threshold 629-g (e.g., maintained in a threshold LUT). For these examples, relationship component 622-3 may have determined that a relationship exists between the file or block based on monitored application data access patterns indicating a given order of access that includes access to data via the related first file or first block followed by access to data via the file or the block. Relationship component 622-3 may place a high relationship value to the related first file or first block based on the monitored application data access pattern indicating the given order of access. The high relationship value may trigger the data compression action decision by action component 622-4. Also for these examples, responsive to time component 622-8 determining that data accessed via the related first file or first block has been accessed within the time threshold, action component 622-4 may determine that a data compression action may include decompressing data if data accessed via the file or block is compressed or determine that the data compression action is to include no compression action if data accessed via the file or the block is not compressed.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

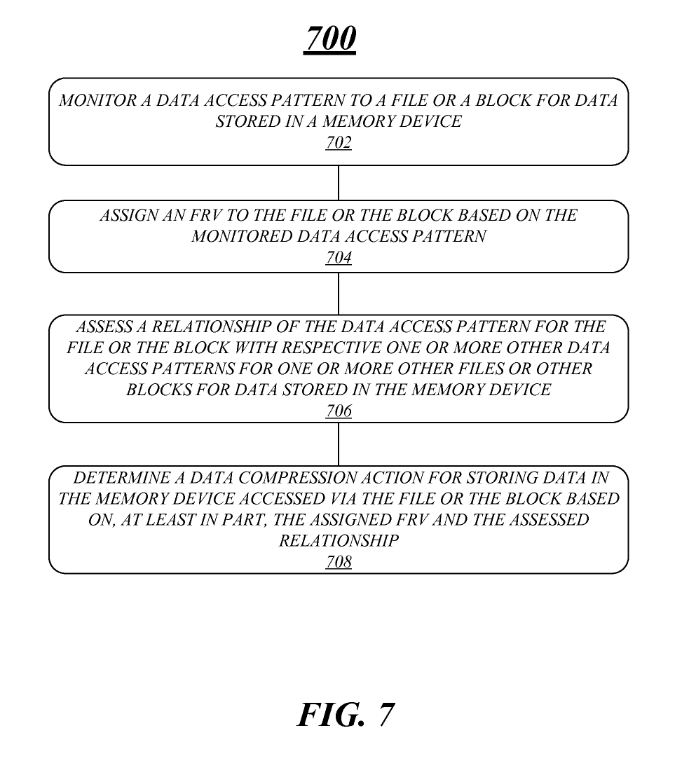

FIG. 7 illustrates an example of a logic flow 700. Logic flow 700 may be representative of some or all of the operations executed by one or more logic, features, or devices described herein, such as apparatus 600. More particularly, logic flow 700 may be implemented by pattern component 622-1, value component 622-2, relationship component 622-3 or action component 622-4.

According to some examples, logic flow 700 at block 702 may monitor a data access pattern to a file or a block for data stored in a memory device. For these examples, pattern component 622-1 may monitor the data access pattern.

In some examples, logic flow 700 at block 704 may assign an FRV to the file or the block based on the monitored data access pattern. For these examples value component 622-2 may assign the FRV.

According to some examples, logic flow 700 at block 706 may assess a relationship of the data access pattern for the file or the block with respective one or more other data access patterns to one or more other files or other blocks for data stored in the memory device. For these examples, relationship component 622-3 may assess the relationship.

In some examples, logic flow 700 at block 708 may determine a data compression action for storing data in the memory device accessed via the file or the block based, at least in part, on the assigned FRV and the assessed relationship. For these examples, action component 622-4 may determine the data compression action.

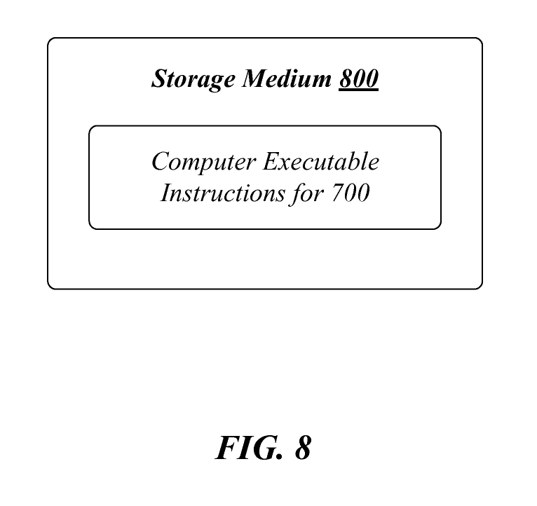

FIG. 8 illustrates an example of a first storage medium. As shown in FIG. 8, the first storage medium includes a storage medium 800. The storage medium 800 may comprise an article of manufacture. In some examples, storage medium 800 may include any non-transitory computer readable medium or machine readable medium, such as an optical, magnetic or semiconductor storage. Storage medium 800 may store various types of computer executable instructions, such as instructions to implement logic flow 700. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

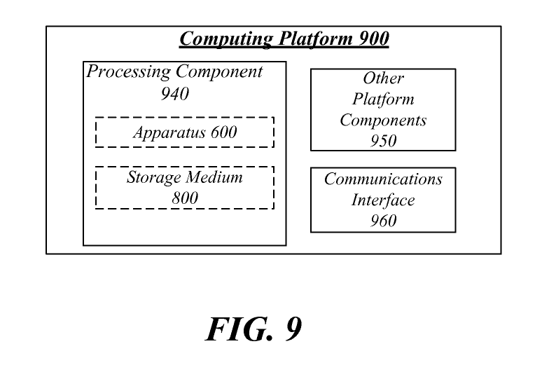

FIG. 9 illustrates an example computing platform 900. In some examples, as shown in FIG. 9, computing platform 900 may include a processing component 940, other platform components or a communications interface 960. According to some examples, computing platform 900 may be part of a host computing platform as mentioned above.

According to some examples, processing component 940 may execute processing operations or logic for apparatus 600 and/or storage medium 800. Processing component 940 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software components, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 950 may include common computing elements or circuitry, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 960 may include logic and/or features to support a communication interface. For these examples, communications interface 960 may include one or more communication interfaces that operate according to various communication protocols or standards to communicate over direct or network communication links. Direct communications may occur via use of communication protocols or standards described in one or more industry standards (including progenies and variants) such as those associated with the SMBus specification or the PCI Express specification. Network communications may occur via use of communication protocols or standards such those described in one or more Ethernet standards promulgated by the Institute of Electrical and Electronics Engineers (IEEE). For example, one such Ethernet standard may include IEEE 802.3-2008, Carrier sense Multiple access with Collision Detection (CSMA/CD) Access Method and Physical Layer Specifications, Published in December 2008 (hereinafter “IEEE 802.3”).

Computing platform 900 may be part of a host computing platform that may be, for example, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of computing platform 900 described herein, may be included or omitted in various embodiments of computing platform 900, as suitably desired.

The components and features of computing platform 900 may be implemented using any combination of discrete circuitry, application specific integrated circuits (ASICs), logic gates and/or single chip architectures. Further, the features of computing platform 900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the example computing platform 900 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The follow examples pertain to additional examples of technologies disclosed herein.

### EXAMPLE 1

An example apparatus may a pattern component for execution by circuitry to monitor a data access pattern to a file or a block for data stored in a memory device. The apparatus may also include a value component for execution by the circuitry to assign an FRV to the file or the block based on the data access pattern monitored by the pattern component. The apparatus may also include a relationship component for execution by the circuity to assess a relationship of the data access pattern for the file or the block with respective one or more other data access patterns to one or more other files or other blocks for data stored in the memory device. The apparatus may also include an action component for execution by the circuitry to determine a data compression action to store data in the memory device accessed via the file or the block based on, at least in part, the assigned FRV and the assessed relationship.

### EXAMPLE 2

The apparatus of example 1 may also include a compression component for execution by the circuitry to compress data accessed via the file or the block responsive to determination by the action component that the data compression action is to include compression of data. For these examples, the compression of data may be via use of a data compression scheme.

### EXAMPLE 3

The apparatus of example 1, data stored in the memory device that is accessed via the file or the block may include compressed data. The apparatus may also include a compression component for execution by the circuitry to decompress compressed data responsive to determination by the action component that the data compression action is to include decompression of data. For these examples, the decompression of data may be via use of a data compression scheme. The apparatus may also include a store component for execution by the circuitry to store decompressed data accessed via the file or the block in the memory device.

### EXAMPLE 4

The apparatus of example 1, the data compression action determined by the action component may include no compression action for data accessed via the file or the block.

### EXAMPLE 5

The apparatus of example 1 may also include a requirement component for execution by the circuitry to receive one or more requirements related to access of data stored in the memory device via the file or the block. For these examples, the action component may determine the data compression action based on the one or more requirements.

### EXAMPLE 6

The apparatus of example 5, the one or more requirements may indicate that data accessed via the block or file is to not be compressed. For these examples, the data compression action determined by the action component may include decompression of data accessed via the file or the block if this data is compressed or no compression action if this data is not compressed.

### EXAMPLE 7

The apparatus of example 5, the requirement component to receive the one or more requirements from an application arranged to access data via the file or the block. For these examples, the application may indicate an access latency threshold in the one or more requirements that would be exceeded if data accessed via file or the block is compressed.

### EXAMPLE 8

The apparatus of example 1, the value component to assign the FRV includes the value component to determine a WEMA based on the data access pattern monitored by the pattern component. For these examples, the WEMA may be represented by FRVₖ=α* FRVₖ₋₁+(1−α)*sample, where FRVₖ represents a new FRV, FRVₖ₌₁ represents an immediately preceding FRV, α represents a weighting decrease value between 0 and 1, and sample represents a value of 1 for an individual file or an individual block that is currently accessed or −1 for an individual file or an individual block that is not currently accessed.

### EXAMPLE 9

The apparatus of example 8, the data compression action determined by the action component may include compression of the data if the FRV assigned by the value component is a lowest value in relation to one or more other assigned FRV values respectively assigned to the one or more other files or other blocks for data stored in the memory device by the value component.

### EXAMPLE 10

The apparatus of example 1, the relationship component to assess the relationship of the data access pattern for the file or the block may include the relationship component to monitor an application data access pattern for data accessed via the file or the block and for data accessed via the one or more other files or other blocks. The relationship component may also determine whether access via the file or the block for the monitored application data access pattern indicates a given order of access that includes access to data via a first file or first block from among the one or more other files or other blocks followed by access to data via the file or the block. The relationship component may also place a high relationship value to the first file or first block if the application data access pattern indicates the given order of access.

### EXAMPLE 11

The apparatus of example 10, may also include a time component for execution by the circuitry to determine whether data accessed via the first file or first block has been accessed within a time threshold. For these example, responsive to determination by the time component that data accessed via the first file or first block has been accessed within the time threshold, the action component may determine that data accessed via the data compression action is to include decompression of data if data accessed via the file or the block is compressed or determine that the data compression action is to include no compression action if data accessed via the file or the block is not compressed.

### EXAMPLE 12

The apparatus of example 1, the memory device may be system memory for a computing device. The monitor component to monitor the data access pattern may include the monitor component to monitor the data access pattern for data accessed via the block that includes a plurality of memory pages. For these examples, the circuitry included in a memory controller for the system memory may have an ability to enable the monitor component to monitor access to data stored at the plurality of memory pages included in the block.

### EXAMPLE 13

The apparatus of example 1, the memory device may be a storage device coupled to a computing device. The monitor component to monitor the data access pattern may include the monitor component to monitor the data access pattern for data accessed via the file. For these examples, the circuitry included in a storage device driver may have an ability to enable the monitor component to monitor access to data accessed via to file.

### EXAMPLE 14

The apparatus of example 1 may also include a digital display coupled to the circuitry to present a user interface view.

### EXAMPLE 15

An example method may include monitoring, at circuity, a data access pattern to a file or a block for data stored at a memory device. The method may also include assigning an FRV to the file or the block based on the monitored data access pattern. The method may also include assessing a relationship of the data access pattern for the file or the block with respective one or more other data access patterns for one or more other files or other blocks for data stored in the memory device. The method may also include determining a data compression action for storing data in the memory device accessed via the file or the block based on, at least in part, the assigned FRV and the assessed relationship.

### EXAMPLE 16

The method of example 15, the data compression action comprising compressing data accessed via the file or the block and storing the compressed data in the memory device, compressing data accessed via the file or the block using a data compression scheme.

### EXAMPLE 17

The method of example 15, data stored in the memory device that is accessed via the file or the block may include compressed data. For these examples, the compression action may include decompressing the compressed data and storing the decompressed data to the memory device, the compressed data decompressed using a data compression scheme.

### EXAMPLE 18

The method of example 15, the data compression action may include no compression action for data accessed via the file or the block.

### EXAMPLE 19

The method of example 15 may also include receiving one or more requirements related to access of data stored in the memory device via the file or the block. The method may also include determining the data compression action also based on the one or more requirements.

### EXAMPLE 20

The method of example 19, the one or more requirements may indicate that data accessed via the file or the block is to not be compressed. For these examples, the data compression action may include decompressing data accessed via the file or the block if this is compressed or no compression action if this data is not compressed.

### EXAMPLE 21

The method of example 19 may include receiving the one or more requirements from an application arranged to access data via the file or the block. For these examples, the application may indicate an access latency threshold in the one or more requirements that would be exceeded if data accessed via file or the block is compressed.

### EXAMPLE 22

The method of example 15, assigning the FRV may include determining a WEMA based on the monitored data access pattern, the WEMA represented by FRVₖ=α* FRVₖ₋₁+(1−α)*sample, where FRVₖ represents a new FRY, FRVₖ₌₁ represents an immediately preceding FRY, α represents a weighting decrease value between 0 and 1, and sample represents a value of 1 for an individual file or an individual block that is currently accessed or −1 for an individual file or an individual block that is not currently accessed.

### EXAMPLE 23

The method of example 22, the data compression action may include compressing data if the assigned FRV is a lowest value in relation to one or more other assigned FRV values respectively assigned to the one or more other file or other blocks for data stored in the memory device.

### EXAMPLE 24

The method of example 15, assessing the relationship of the data access pattern for the file or the block may also include monitoring an application data access pattern for data accessed via the file or the block and for data accessed via to the one or more other files or other blocks. Assessing the relationship may also include determining whether access via the file or the block for the monitored application data access pattern indicates a given order of access that includes access to data via a first file or first block from among the one or more other files or other blocks followed by access to data via the file or the block. Assessing the relationship may also include placing a high relationship value to the first file or first block if the application data access pattern indicates the given order of access.

### EXAMPLE 25

The method of example 24 may also include determining whether data accessed via the first file or first block has been accessed within a time threshold and responsive to determining that data accessed via the first file or first block has been accessed within the time threshold, determining that the data compression action is to include decompressing data if data accessed via the file or the block is compressed or determine that the data compression action is to include no compression action if data accessed via the file or the block is not compressed.

### EXAMPLE 26

The method of example 15, the memory device may be system memory for a computing device. For these examples, monitoring the data access pattern includes monitoring the data access pattern for data accessed via the block that includes a plurality of memory pages. The circuitry may be included in a memory controller for the system memory having an ability to monitor access to data stored at the plurality of memory pages included in the block.

### EXAMPLE 27

The method of example 15, the memory device may include a storage device coupled to a computing device. For these examples, monitoring the data access pattern may include monitoring the data access pattern for data accessed via the file. The circuitry may be included in a storage device driver having an ability to monitor access to data accessed via the file.

### EXAMPLE 28

An example at least one machine readable medium may include a plurality of instructions that in response to being executed by system may cause the system to carry out a method according to any one of examples 15 to 27.

### EXAMPLE 29

An example apparatus may include means for performing the methods of any one of examples 15 to 27.

### EXAMPLE 30

An example at least one machine readable medium may include a plurality of instructions that in response to being executed by system may cause the system to monitor a data access pattern to a file or a block for data stored in a memory device. The instructions may also cause the system to assign an FRV to the file or the block based on the monitored data access pattern. The instructions may also cause the system to assess a relationship of the data access pattern for the file or the block with respective one or more other data access patterns for one or more other files or other blocks for data stored in the memory device. The instructions may also cause the system to determine a data compression action for storing data in the memory device accessed via the file or the block based on, at least in part, the assigned FRV and the assessed relationship.

### EXAMPLE 31

The at least one machine readable medium of example 30, the data compression action may include compressing data accessed via the file or the block and storing the compressed data to the memory device, compressing data accessed via the file or the block using a data compression scheme.

### EXAMPLE 32

The at least one machine readable medium of example 30, data stored in the memory device that is accessed via the file or the block may include compressed data. For these examples, the compression action to include decompressing the compressed data and storing the decompressed data in the memory device, the compressed data decompressed using a data compression scheme.

### EXAMPLE 33

The at least one machine readable medium of example 30, the data compression action may include no compression action for data accessed via the file or the block.

### EXAMPLE 34

The at least one machine readable medium of example 30, the instructions may further cause the system receive one or more requirements related to access of data stored in the memory device via the file or the block. The instructions may also determine the data compression action also based on the one or more requirements.

### EXAMPLE 35

The at least one machine readable medium of example 34, the one or more requirements may indicate that data accessed via the file or the block is to not be compressed. For these examples, the data compression action may include decompressing data accessed via the file or the block if this is compressed or no compression action if this data is not compressed.

### EXAMPLE 36

The at least one machine readable medium of example 34, the instructions may cause the system to receive the one or more requirements from an application arranged to access data via the file or the block. For these examples, the application may indicate an access latency threshold in the one or more requirements that would be exceeded if data accessed via file or the block is compressed.

### EXAMPLE 37

The at least one machine readable medium of example 30, the instructions to cause the system to assign the FRV may include the system to determine a WEMA based on the monitored data access pattern. For these examples, the WEMA may be represented by FRVₖ =α*FRVₖ₋₁+(1−α)*sample, where FRVₖ represents a new FRV, FRVₖ₌₁ represents an immediately preceding FRV, α represents a weighting decrease value between 0 and 1, and sample represents a value of 1 for an individual file or an individual block that is currently accessed or −1 for an individual file or an individual block that is not currently accessed.

### EXAMPLE 38

The at least one machine readable medium of example 37, the data compression action to include compressing data if the assigned FRV is a lowest value in relation to one or more other assigned FRV values respectively assigned to the one or more other files or other blocks for data stored in the memory device.

### EXAMPLE 39

The at least one machine readable medium of example 30, the instructions to cause the system to assess the relationship of the data access pattern for the file or the block may further include the instructions to cause the system to monitor an application data access pattern for data accessed via the file or the block and for data accessed via to the one or more other files or other blocks. The system to assess the relationship may also include the system to determine whether access via the file or the block for the monitored application data access pattern indicates a given order of access that includes access to data via a first file or first block from among the one or more other files or other blocks followed by access to data via the file or the block. The system to assess the relationship may also include the system to place a high relationship value to the first file or first block if the application data access pattern indicates the given order of access.

### EXAMPLE 40

The at least one machine readable medium of example 39, the instructions to further cause the system to determine whether data accessed via the first file or first block has been accessed within a time threshold. For these examples, responsive to a determination that data accessed via the first file or first block has been accessed within the time threshold, the instructions may also cause the system to determine that the data compression action is to include decompressing data if data accessed via the file or the block is compressed or determine that the data compression action is to include no compression action if data accessed via the file or the block is not compressed.

### EXAMPLE 41

The at least one machine readable medium of example 30, the memory device may be system memory for a computing device. For these examples, the instructions to cause the system to monitor the data access pattern may include the system to monitor the data access pattern for data accessed via the block that includes a plurality of memory pages. The system may be included in a memory controller for the system memory. The memory controller may have an ability to monitor access to data stored at the plurality of memory pages included in the block.

### EXAMPLE 42

The at least one machine readable medium of example 30, the memory device may include a storage device coupled to a computing device. For these examples, the system to monitor the data access pattern includes the system to monitor the data access pattern for data accessed via the file. The system included in a storage device driver that has an ability to monitor access to data accessed via the file.

### EXAMPLE 43

An example first system may include a storage device having one or more memory devices. The first system may also include a storage device driver for execution by circuitry at a computing device coupled with the storage device. For these examples, the storage device driver may monitor a data access pattern to a file for data stored in the one or more memory devices. The storage device driver may also assign an FRV to the file based on the monitored data access pattern. The storage device driver may also assess a relationship of the data access pattern for the file with respective one or more other data access patterns for one or more other files for data stored in the one or more memory devices. The storage device driver may also determine a data compression action for storing data in the one or more memory devices accessed via the file based on, at least in part, the assigned FRV and the assessed relationship.

### EXAMPLE 44

The first system of claim 43, data stored in the one or more memory devices that is accessed via the file may include compressed data. For these examples, the compression action may include decompressing the compressed data and storing the decompressed data in the one or more memory devices, the compressed data decompressed using a data compression scheme.

### EXAMPLE 45

The first system of claim 43, the data compression action may include no compression action for data accessed via the file.

### EXAMPLE 46

The first system of claim 43, the storage device driver may assign the FRV includes the storage device driver to determine a WEMA based on the monitored data access pattern, the WEMA represented by FRVₖ=α*FRVₖ₋₁+(1−α)*sample, where FRVₖ represents a new FRV, FRVₖ₌₁ represents an immediately preceding FRV, α represents a weighting decrease value between 0 and 1, and sample represents a value of 1 for an individual file that is currently accessed or −1 for an individual file that is not currently accessed.

### EXAMPLE 47

The first system of claim 46, the data compression action may include compressing data if the assigned FRV is a lowest value in relation to one or more other assigned FRV values respectively assigned to the one or more other files for data stored in the one or more memory devices.

### EXAMPLE 48

An example second system may include system memory having one or more memory devices. The second system may also include a memory controller coupled with the system memory. The memory controller to be executed by circuitry of a computing platform. For these examples, the memory controller may monitor a data access pattern to a block for data stored in the one or more memory devices. The memory controller may also assign an FRV to the block based on the monitored data access pattern. The memory controller may also assess a relationship of the data access pattern for the block with respective one or more other data access patterns for one or more other blocks for data stored in the one or more memory devices. The memory controller may also determine a data compression action for storing data in the one or more memory devices accessed via the block based on, at least in part, the assigned FRV and the assessed relationship.

### EXAMPLE 49

The second system of claim 48, data stored in the one or more memory devices that is accessed via the block may include compressed data. For these examples, the compression action may include decompressing the compressed data and storing the decompressed data in the one or more memory devices, the compressed data decompressed using a data compression scheme.

### EXAMPLE 50

The second system of claim 48, the data compression action may include no compression action for data accessed via the block.

### EXAMPLE 51

The second system of claim 48, the memory controller to assign the FRV includes the memory controller to determine a WEMA based on the monitored data access pattern. For these examples, the WEMA may be represented by FRVₖ=α*FRVₖ₋₁+(1−α)*sample, where FRVₖ represents a new FRV, FRVₖ₌₁ represents an immediately preceding FRV, α represents a weighting decrease value between 0 and 1, and sample represents a value of 1 for an individual file that is currently accessed or −1 for an individual file that is not currently accessed.

### EXAMPLE 52

The second system of claim 51, the data compression action to include compressing data if the assigned FRV is a lowest value in relation to one or more other assigned FRV values respectively assigned to the one or more other blocks for data stored in the one or more memory devices.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a pattern component for execution by circuitry to monitor a data access pattern to a file or a block for data stored in a memory device;
a value component for execution by the circuitry to assign a frequency-recency value (FRV) to the file or the block based on the data access pattern monitored by the pattern component;
a relationship component for execution by the circuity to assess a relationship of the data access pattern for the file or the block with respective one or more other data access patterns to one or more other files or other blocks for data stored in the memory device; and
an action component for execution by the circuitry to determine a data compression action to store data in the memory device accessed via the file or the block based on, at least in part, the assigned FRV and the assessed relationship.

2. The apparatus of claim 1, comprising:
a compression component for execution by the circuitry to compress data accessed via the file or the block responsive to determination by the action component that the data compression action is to include compression of data via use of a data compression scheme; and
a store component for execution by the circuitry to store compressed data accessed via the file or the block in the memory device.

3. The apparatus of claim 1, comprising:
data stored in the memory device that is accessed via the file or the block comprises compressed data:
a compression component for execution by the circuitry to decompress compressed data responsive to determination by the action component that the data compression action is to include decompression of data via use of a data compression scheme; and
a store component for execution by the circuitry to store decompressed data accessed via the file or the block in the memory device.

4. The apparatus of claim 1, the data compression action determined by the action component comprising no compression action for data accessed via the file or the block.

5. The apparatus of claim 1, comprising:
a requirement component for execution by the circuitry to receive one or more requirements related to access of data stored in the memory device via the file or the block; and
the action component to also determine the data compression action based on the one or more requirements.

6. The apparatus of claim 5, the one or more requirements indicate that data accessed via the block or file is to not be compressed, the data compression action determined by the action component to include decompression of data accessed via the file or the block if this data is compressed or no compression action if this data is not compressed.

7. The apparatus of claim 5, the requirement component to receive the one or more requirements from an application arranged to access data via the file or the block, the application to indicate an access latency threshold in the one or more requirements that would be exceeded if data accessed via file or the block is compressed.

8. The apparatus of claim 1, the value component to assign the FRV comprises the value component to determine a weighted exponentially moving average (WEMA) based on the data access pattern monitored by the pattern component, the WEMA represented by:
FRVₖ=α*FRVₖ₋₁+(1−α)*sample,
where FRVk represents a new FRV,
FRVₖ₌₁ represents an immediately preceding FRV,
α represents a weighting decrease value between 0 and 1, and
sample represents a value of 1 for an individual file or an individual block that is currently accessed or −1 for an individual file or an individual block that is not currently accessed.

9. The apparatus of claim 8, the data compression action determined by the action component to include compression of the data if the FRV assigned by the value component is a lowest value in relation to one or more other assigned FRV values respectively assigned to the one or more other files or other blocks for data stored in the memory device by the value component.

10. The apparatus of claim 1, the relationship component to assess the relationship of the data access pattern for the file or the block further comprises the relationship component to:
monitor an application data access pattern for data accessed via the file or the block and for data accessed via the one or more other files or other blocks;
determine whether access via the file or the block for the monitored application data access pattern indicates a given order of access that includes access to data via a first file or first block from among the one or more other files or other blocks followed by access to data via the file or the block; and
place a high relationship value to the first file or first block if the application data access pattern indicates the given order of access.

11. The apparatus of claim 10, comprising:
a time component for execution by the circuitry to determine whether data accessed via the first file or first block has been accessed within a time threshold; and
responsive to determination by the time component that data accessed via the first file or first block has been accessed within the time threshold, the action component to determine that data accessed via the data compression action is to include decompression of data if data accessed via the file or the block is compressed or determine that the data compression action is to include no compression action if data accessed via the file or the block is not compressed.

12. The apparatus of claim 1, the memory device comprising system memory for a computing device, the monitor component to monitor the data access pattern includes the monitor component to monitor the data access pattern for data accessed via the block that includes a plurality of memory pages, the circuitry included in a memory controller for the system memory to have an ability to enable the monitor component to monitor access to data stored at the plurality of memory pages included in the block.

13. The apparatus of claim 1, the memory device comprising a storage device coupled to a computing device, the monitor component to monitor the data access pattern includes the monitor component to monitor the data access pattern for data accessed via the file, the circuitry included in a storage device driver to have an ability to enable the monitor component to monitor access to data accessed via the file.

14. The apparatus of claim 1, comprising a digital display coupled to the circuitry to present a user interface view.

15. A method comprising:
monitoring, at circuity, a data access pattern to a file or a block for data stored in a memory device;
assigning a frequency-recency value (FRV) to the file or the block based on the monitored data access pattern;
assessing a relationship of the data access pattern for the file or the block with respective one or more other data access patterns for one or more other files or other blocks for data stored in the memory device; and
determining a data compression action for storing data in the memory device accessed via the file or the block based on, at least in part, the assigned FRV and the assessed relationship.

16. The method of claim 15, the data compression action comprising compressing data accessed via the file or the block and storing the compressed data in the memory device, compressing data accessed via the file or the block using a data compression scheme.

17. The method of claim 15, the data compression action comprising no compression action for data accessed via the file or the block.

18. The method of claim 15, assigning the FRV includes determining a weighted exponentially moving average (WEMA) based on the monitored data access pattern, the WEMA represented by:
FRVₖ=α*FRVₖ₋₁+(1−α)*sample,
where FRVₖ represents a new FRV,
FRVₖ₌₁ represents an immediately preceding FRV,
α represents a weighting decrease value between 0 and 1, and
sample represents a value of 1 for an individual file or an individual block that is currently accessed or −1 for an individual file or an individual block that is not currently accessed.

19. The method of claim 18, the data compression action to include compressing data if the assigned FRV is a lowest value in relation to one or more other assigned FRV values respectively assigned to the one or more other file or other blocks for data stored in the memory device.

20. The method of claim 15, assessing the relationship of the data access pattern for the file or the block further comprising:
monitoring an application data access pattern for data accessed via the file or the block and for data accessed via to the one or more other files or other blocks;
determining whether access via the file or the block for the monitored application data access pattern indicates a given order of access that includes access to data via a first file or first block from among the one or more other files or other blocks followed by access to data via the file or the block; and
placing a high relationship value to the first file or first block if the application data access pattern indicates the given order of access.

21. A system comprising:
a storage device having one or more memory devices; and
a storage device driver for execution by circuitry at a computing device coupled with the storage device, the storage device driver to:
monitor a data access pattern to a file for data stored in the one or more memory devices;
assign a frequency-recency value (FRV) to the file based on the monitored data access pattern;
assess a relationship of the data access pattern for the file with respective one or more other data access patterns for one or more other files for data stored in the one or more memory devices; and
determine a data compression action for storing data in the one or more memory devices accessed via the file based on, at least in part, the assigned FRV and the assessed relationship.

22. The system of claim 21, data stored in the one or more memory devices that is accessed via the file comprises compressed data, the compression action to include decompressing the compressed data and storing the decompressed data in the one or more memory devices, the compressed data decompressed using a data compression scheme.

23. The system of claim 21, the data compression action comprising no compression action for data accessed via the file.

24. The system of claim 21, the storage device driver to assign the FRV includes the storage device driver to determine a weighted exponentially moving average (WEMA) based on the monitored data access pattern, the WEMA represented by:
FRVₖ=α*FRVₖ₋₁+(1−α)*sample,
where FRVk represents a new FRV,
FRVₖ₌₁ represents an immediately preceding FRV,
α represents a weighting decrease value between 0 and 1, and
sample represents a value of 1 for an individual file that is currently accessed or −1 for an individual file that is not currently accessed.

25. The system of claim 24, the data compression action to include compressing data if the assigned FRV is a lowest value in relation to one or more other assigned FRV values respectively assigned to the one or more other files for data stored in the one or more memory devices.
